(19) United States
(12) Patent Application Publication
(10) Pub. No.: US 2022/0387151 A1
(43) Pub. Date: Dec. 8, 2022

(54) Orthodontic Appliances, Orthodontic Appliance Preforms And Methods Of Forming Orthodontic Appliances

(71) Applicant: Waqas Wahab, Lahore (PK)

(72) Inventor: Waqas Wahab, Lahore (PK)

(21) Appl. No.: 17/497,130

(22) Filed: Oct. 8, 2021

Related U.S. Application Data
(60) Provisional application No. 63/089,464, filed on Oct. 8, 2020.

(51) Int. Cl. A61C 13/34; A61C 7/08; A61C 7/02

(52) U.S. Cl. CPC A61C 13/34; A61C 7/08; A61C 7/02

(57) ABSTRACT

Thermoforming methods of making orthodontic appliances and orthodontic appliances preforms employ a barrier sheet positioned between an appliance sheet and a dental model during the forming step. The thermoformed orthodontic appliances are more pellucid than appliances thermoformed without the barrier sheet.

### RELATED APPLICATION DATA

This application claims the benefit of U.S. Provisional Patent Application Ser. No. 63/089,464, filed Oct. 8, 2020, which is hereby incorporated by reference.

Methods of producing orthodontic appliances having improved translucency, orthodontic appliances and orthodontic appliance preforms. The orthodontic appliances comprise a polymeric shell with multiple teeth receiving cavities.

### BACKGROUND

An objective of orthodontics is to reposition teeth of a patient while keeping in mind the function and/or aesthetics of appliances worn by the patient during treatment. Conventionally, appliances such as braces are applied to a patient's teeth by an orthodontist or dentist and the set of braces exerts continual optimum force on the teeth and gradually urges them toward their intended positions over time. Patients undergoing orthodontic treatment with metal brackets, however, may feel embarrassed by the visibility of the metal, which is not usually considered aesthetically pleasing. To address the unsightliness of metal brackets, certain known orthodontic brackets incorporate a bracket body of a transparent or translucent non-metallic material, such as a clear or translucent polymer or a clear or translucent ceramic that is intended to match the shade of the patient's underlying tooth. Lingual braces have the same components as conventional braces but are bonded to the lingual surface of a patient's teeth. Since lingual braces are on the back of the patient's teeth, they are not generally visible to others.

Alternatives to orthodontic braces include other clear or less visually discernable appliances. The most common of these are the so-called “aligners.” Moreover, retainers are also plastic appliances provided to patients to hold the patients' teeth in their positions after aligning them or after surgery. Retainers are made from a variety of materials including polymeric materials.

Many features have been incorporated into clear aligners for various purposes including enhancing performance, enhancing comfort, maintaining conformation and/or resisting wear and relaxation of the appliance. Various types of aligners have been disclosed, including fluid permeable aligners, modular aligners, wrinkled aligners, aligners of varying thickness, aligners of varying stiffness, textured aligners and aligners having multiple layers.

Orthodontic appliances are commonly made by thermoforming. Thermoforming is a manufacturing process where a plastic sheet is heated to a pliable forming temperature, formed to a specific shape in a mold, and trimmed to create a usable product. The thermoforming of orthodontic appliances typically comprises several steps. Initially, a dental model, aka a dental mould, is made. The dental model is initially formed from an impression of the patient's teeth. For some procedures, such as orthodontic realignment of teeth with aligners, the dental model initially formed is subsequently manipulated in one of various ways to change the alignment or configuration of the teeth on the model. Orthodontic appliances are formed at multiple stages with the dental model in a series of slightly different configurations representing the patient's teeth configuration at the start of the realignment process and progressing in steps to the patient's desired teeth configuration. The second step is to provide a sheet of the material from which the orthodontic appliance will be formed. This sheet is referred to herein as the “appliance sheet”. Appliance sheets are commonly formed of one or more polymeric materials. The appliance sheet is then heated to a desired pliability and placed onto a dental model and subjected to forces, using either a vacuum or positive pressure, in a pressurized chamber in order to cause the pliable, heated appliance sheet to form an orthodontic appliance which conforms to the shape of the dental model. After removal from the chamber, excess material is typically removed from the newly formed appliance and the appliance is ready for use on the patient.

The purpose of the presently disclosed methods, orthodontic appliances and appliance preforms is to enhance translucency in orthodontic appliances.

### SUMMARY

The disclosed methods relate to the thermoforming of thermoplastic orthodontic appliances and orthodontic appliance preforms. More specifically, disclosed are new and improved methods of making thermoplastic orthodontic appliances comprising a unique translucency.

In one method, a positive dental arch/model is provided. In addition to a conventional “appliance sheet”, a second “barrier” sheet of polymeric material is positioned between the appliance sheet and the dental model. The thermoforming process comprises heating both the appliance sheet and the barrier sheet which are then formed via pressure or vacuum into the shape of the desired orthodontic appliance. In other words, the sheets are moulded onto the positive mould of the dental model. After the thermoforming cycle is completed, the dental model and molded sheets are removed from the thermoforming machine.

According to the disclosed thermoforming processes, both the appliance sheet and the barrier sheet are molded into the shape of the dental model during the thermoforming process. The molded orthodontic appliance and attached molded barrier sheet are referred to herein as an orthodontic appliance preform.

The moulded orthodontic appliance and the moulded barrier sheet are removed from the dental model either simultaneously or consecutively and, in either case, the barrier sheet is separated from the molded appliance.

The orthodontic appliance is then trimmed and ready for use in a patient.

From the present description, it will be understood that the thin layer of polymeric “barrier” sheet positioned between the dental model and the appliance sheet prevents direct contact between the appliance sheet and the dental model. The barrier sheet shields the appliance from acquiring any undesirable impurities present on the dental model and avoids any undesired colour change or loss of translucency caused by such impurities during the thermoforming process. Thermoforming an orthodontic appliance via this method helps in achieving a more pellucid appliance.

### BRIEF DESCRIPTION OF THE DRAWINGS

FIG. 1 is a diagram of the initial heating step of a disclosed thermoforming process.

FIG. 2 illustrates the placement of the heated appliance sheet and barrier sheet onto a dental mould after the sheets have been heated.

FIG. 3 generally illustrates the application of a positive air pressure to the side of the sheets generally opposite the dental mould.

FIG. 4 generally illustrates the thermoformed orthodontic appliance with the barrier sheet still attached.

FIG. 5 is a representation of an orthodontic appliance after the barrier sheet has been removed.

FIG. 6 is an illustration of a positive pressure thermoforming machine during the initial sheet heating step.

FIG. 7 is an illustration of a positive pressure thermoforming machine after heating of the sheets and prior to the forming step.

FIG. 8 illustrates a thermoformed orthodontic appliance with the barrier sheet still attached.

FIG. 9 illustrates an orthodontic appliance after the barrier sheet has been removed.

FIG. 10 is a side-by-side comparison of portions of an orthodontic appliance of the present invention and without a barrier sheet.

### DETAILED DESCRIPTION

One aspect comprises a method of thermoforming an orthodontic appliance which includes the placement of a barrier sheet between an appliance sheet and a dental model during the thermoforming process. It is presently believed that the barrier sheet prevents impurities which may be present on the dental model from getting into the outer surface of the formed orthodontic appliance. Sometimes there are small indentations, lines and/or rough surfaces on the teeth models and the barrier sheet protects the appliance sheet from conforming to those small indentations/lines whose presence degrades the clarity of the formed appliance. It is believed that the presence of the barrier sheet essentially presents the appliance sheet with a smoother surface on which to conform to the shape of the dental model during the actual forming step. The presence of the barrier sheet results in a clearer, more pellucid orthodontic appliance.

Another aspect comprises orthodontic appliances formed by a novel thermoforming method described below.

Another aspect comprises orthodontic appliance preforms comprising a molded orthodontic appliance and a molded barrier sheet. The disclosed methods relate to the thermoforming of plastic orthodontic appliances. More specifically, disclosed are new and improved methods of making thermoplastic orthodontic appliances comprising a unique translucency. Any orthodontic appliances which can be thermoformed and which can benefit from greater translucency, such as aligners, retainers, orthodontic splints, and tooth positioners can be made using the disclosed processes.

In one method, a positive dental arch/model is provided. The dental model is placed on the platform of a thermoforming machine. A sheet of material which will be thermoformed into the orthodontic appliance, i.e. the “appliance sheet”, and a second “barrier” sheet of polymeric material are placed in the thermoforming machine and, at the proper point in time, positioned on the dental model (positive mould) with the barrier sheet positioned below the appliance sheet, i.e. between the appliance sheet and the dental model. The thermoforming machine preferably applies heat to both sheets simultaneously (but not necessarily evenly) to make the sheets sufficiently pliable. The sheets are preferably heated to their respective thermoforming temperatures or to a temperature which is substantially their thermoforming temperatures. The precise thermoforming temperatures utilized will depend on the composition of the appliance sheet and of the barrier sheet.

In one embodiment, the compositions of the appliance sheet and the barrier sheet are selected so that their respective thermoforming temperatures do not differ by more than 25° C. In another embodiment, the compositions of the appliance sheet and the barrier sheet are selected so that their respective thermoforming temperatures do not differ by more than 15° C. In another embodiment, the compositions of the appliance sheet and the barrier sheet are selected so that their respective thermoforming temperatures do not differ by more than 5° C. And in still another embodiment, the compositions of the appliance sheet and the barrier sheet are selected so that their respective thermoforming temperatures do not differ by more than 2° C.

The sheets are forced via pressure or vacuum into the shape of the orthodontic appliance. In other words, the sheets are moulded onto the positive mould of the dental model. After the thermoforming cycle is completed, the dental model and molded sheets are removed from the thermoforming machine.

According to the disclosed thermoforming processes, both the appliance sheet and the barrier sheet are molded into the shape of the dental model during the thermoforming process. The phrase “molded into the shape of the dental mold” and similar phrases indicate that the formed orthodontic appliance, barrier sheet and dental preform have cavities corresponding to the shape of the dental preform, not that the formed articles are formed inito the same shape as the dental model. The molded orthodontic appliance and attached molded barrier sheet are referred to herein as an orthodontic appliance preform.

The moulded orthodontic appliance and the moulded barrier sheet are removed from the dental model either simultaneously or consecutively and, in either case, the barrier sheet is separated from the molded appliance.

The orthodontic appliance is then trimmed and ready for use in a patient.

The disclosed methods can be readily performed using known orthodontic appliance thermoforming equipment which use either positive pressure or a vacuum during the thermoforming process. The Biostar® and MiniSTAR® thermoforming machines available from Great Lakes Dental Technologies, in Tonawanda, New York, USA are examples of positive pressure thermoforming equipment which can be utilized to perform the disclosed processes.

From the present description, it will be understood that the thin layer of polymeric “barrier” sheet positioned between the dental model and the appliance sheet prevents direct contact between the appliance sheet and the dental model. The barrier sheet shields the appliance from acquiring any undesirable impurities present on the dental model and avoids any undesired colour change or loss of translucency caused by such impurities during the thermoforming process. Thermoforming an appliance via this method helps in achieving a more pellucid appliance.

FIG. 1 generally illustrates a positive dental arch 40 placed on the platform of a thermoforming heater of thermoforming machine 10 which provides the heat to an appliance sheet 20 placed underneath the heater. Appliance sheets are known in the industry and vary in composition and thickness depending on the manufacturer and the appliance being formed. The appliance sheet 20 preferably has a thickness of about 0.1 mm to about 5 mm. According to the present methods, in addition to the plastic appliance sheet 20 used to make the orthodontic appliance, another thin protective barrier sheet 30 is positioned between the dental model 40 and the appliance sheet 20. Barrier sheet 30 is an additional material layer not found in conventional aligner (or other orthodontic appliance) forming processes. Barrier sheet 30 will not allow the appliance sheet 20 and the positive mould of teeth 40 to come in direct contact with each other during the thermoforming procedure. While it is currently believed easier and more efficient to shield the entire the appliance sheet from the dental model with the barrier sheet, there is no benefit gained from shielding the portion of the appliance sheet which will be trimmed and discarded after the thermoforming process, so a barrier sheet can be utilized to only shield a predetermined portion of the appliance sheet, if desired.

The barrier sheet 30 is not necessarily the same thickness as the appliance sheet 20, and is preferably significantly thinner, for example, about 0.05 mm to about 0.5 mm in thickness. Barrier sheet 30 is formed of a thermoformable polymer or polymeric blend which will not adversely affect or react with the appliance sheet and will be readily separable from the formed appliance.

The barrier sheet 30 can be optionally attached to the appliance sheet before the thermoforming process. The barrier sheet can also be provided to the lab or technician along with the appliance sheet as a two-ply sheet to facilitate efficiency in handling during the thermoforming process. Alternatively, the barrier sheet can be placed on the dental model before the appliance sheet is placed on the barrier sheet.

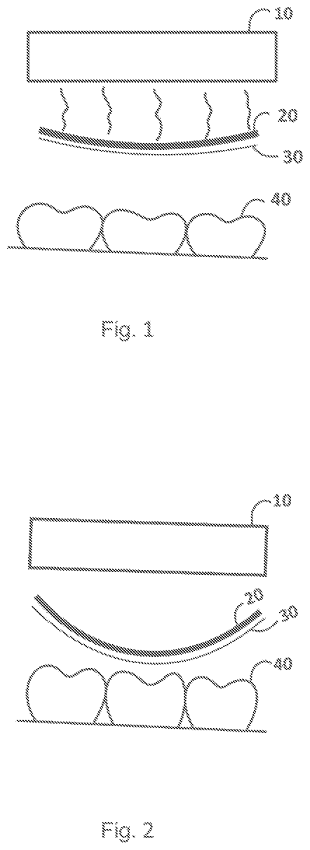

FIG. 2 generally illustrates the sagging of appliance sheet 20 and the protective barrier sheet 30 after heat has been applied for some initial time. Different plastic sheets, i.e. sheets formed of different materials and sheets of various thicknesses, will require different levels of heat and/or time to reach the stage where the two plastic sheets sag and become sufficiently soft and pliable forming on the positive mould of teeth 40.

FIG. 3 generally illustrates the adaptation of appliance sheet 20 as well as the barrier sheet 30 to the shape of the positive mould of teeth 40, with positive pressure of air coming from the top of the thermoforming equipment to facilitate better adaptation of the appliance sheet 2 to the shape of the dental model 4. Appliance sheet 20 is thereby conformed to the shape of the teeth of the positive dental arch 40 but never comes into direct contact with the positive mould 40 because of the protective sheet 30 present positioned between them. The

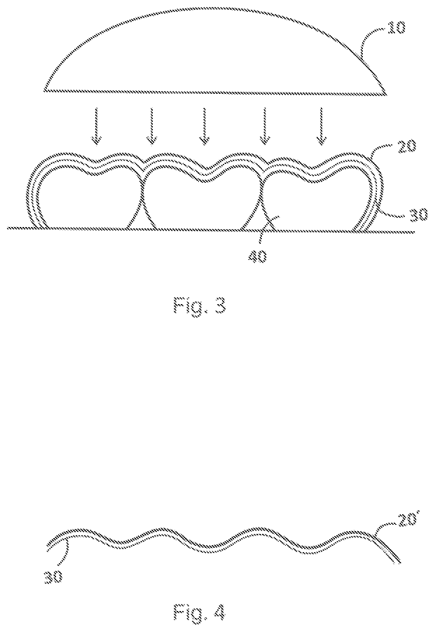

FIG. 4 shows an orthodontic appliance preform comprising the formed orthodontic appliance 20′ and the molded protective barrier sheet 30.

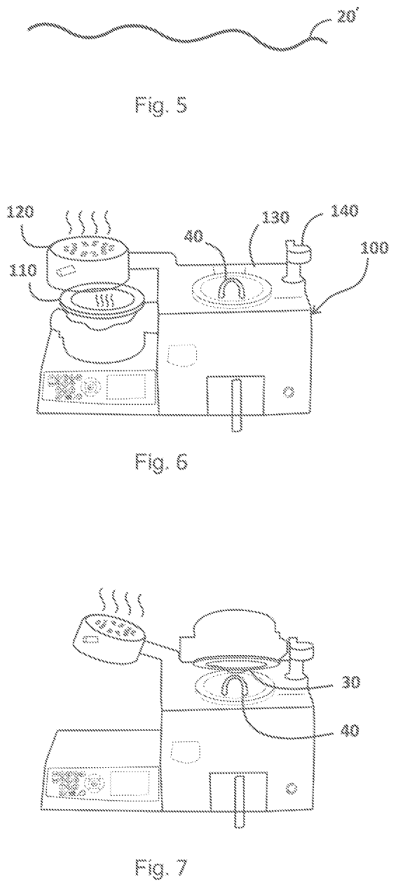

FIG. 5 shows the final translucent plastic orthodontic appliance 20′ after the removal of the molded protective barrier sheet 30.

Protective barrier sheet 30 is sufficiently thin that it does not interfere with the desired conformation of the molded orthodontic appliance (formed from the appliance sheet) with the detailed anatomy of the positive mould of patient's teeth (dental model) 40 or the subsequent fit of the orthodontic appliance on the patient's teeth.

FIG. 6 generally illustrates a positive pressure thermoforming machine 100 in the style of those offered by Great Lakes Dental Technologies which include a rotatable support 110 for supporting the appliance sheet and the barrier sheet. The support 110 holds the sheets during heating by a pivotal heat element 120. Heating element 120 is designed to heat the sheets which are positioned below the heater. After heating, the support 110 rotates the heated sheets onto the forming platform 130 which is already supporting a dental model 40. The support 110 forms the upper portion of the positive pressure chamber while the forming platform 130 forms the lower portion of the positive pressure chamber. After the support 110 is sealed in place with lock 140, air pressure is applied to the top of the pressure chamber causing the now pliable sheets to form on the dental model 40. FIG. 6 illustrates this positive pressure thermoforming machine during the initial sheet heating step.

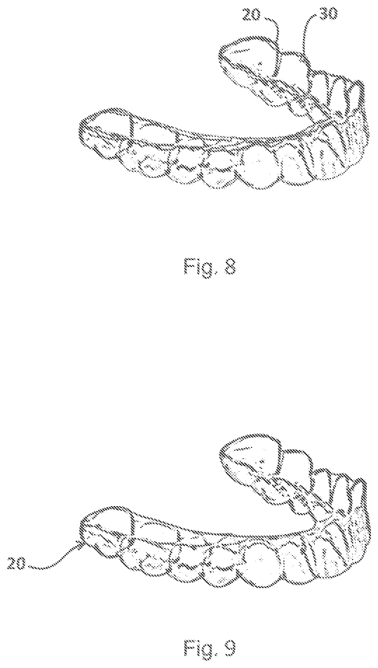

FIG. 7 illustrates a thermoforming machine of FIG. 6 just prior to the sealing of the pressure chamber in which the forming takes place. The heated barrier sheet 30 can be seen to be sagging toward the dental model 40.

FIG. 8 illustrates an orthodontic appliance preform including a thermoformed orthodontic appliance with the barrier sheet still attached.

FIG. 9 illustrates an orthodontic appliance after the barrier sheet has been removed.

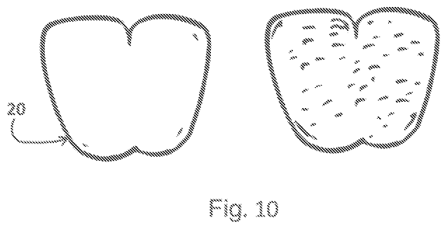

FIG. 10 is a side-by-side comparison of portions of an orthodontic appliance of the present invention and without a barrier sheet. The appliance portion on the left is much clearer than the appliance portion on the right in FIG. 10. The appliance portion on the right has numerous visible, light scattering imperfections which degrade the clarity of the appliance.

1. A method of thermoforming an orthodontic appliance comprising the steps of:
providing a dental model;
providing an appliance sheet and a barrier sheet;
heating the appliance sheet and the barrier sheet until the appliance sheet and barrier sheet are pliable;
positioning the appliance sheet and the barrier sheet proximate the dental model with the barrier sheet positioned between the dental model and the appliance sheet; and
applying sufficient pressure to the appliance sheet to cause the appliance sheet to be formed into an orthodontic appliance comprising at least one opening conforming to the shape of the dental model.

2. A method of thermoforming an orthodontic appliance according to claim 1 wherein said appliance sheet and said barrier sheet comprise polymeric materials.

3. A method of thermoforming an orthodontic appliance according to claim 1 wherein heating step comprises heating said appliance sheet and said barrier sheet to substantially their respective thermoforming temperatures.

4. A method of thermoforming an orthodontic appliance according to claim 1 wherein said appliance sheet has a thickness of about 0.1 mm to about 5 mm

5. A method of thermoforming an orthodontic appliance according to claim 1 wherein said barrier sheet has a thickness of about 0.05 mm to about 0.5 mm.

6. A method of thermoforming an orthodontic appliance according to claim 1 wherein said step of providing an appliance sheet and a barrier sheet comprise providing sheets with respective thermoforming temperatures which do not differ by more than 15° C.

7. A method of thermoforming an orthodontic appliance according to claim 1 wherein said step of providing an appliance sheet and a barrier sheet comprise providing sheets with respective thermoforming temperatures which do not differ by more than 5° C.

8. A method of thermoforming an orthodontic appliance according to claim 1 wherein said step of providing an appliance sheet and a barrier sheet comprise providing sheets with respective thermoforming temperatures which do not differ by more than 2° C.

9. A method of thermoforming an orthodontic appliance according to claim 1 wherein said positioning step comprises positioning said appliance sheet over said dental model.

10. A method of thermoforming an orthodontic appliance according to claim 1 wherein said positioning step comprises positioning said barrier sheet such that the barrier sheet prevents contact between the appliance sheet and the dental model.

11. An orthodontic appliance formed by the method of claim 1.

12. An orthodontic appliance preform comprising an orthodontic appliance and a thermoformed barrier sheet formed by the method of claim 1.
